(19) United States
(12) Patent Application Publication
(10) Pub. No.: US 2016/0341418 A1
(43) Pub. Date: Nov. 24, 2016

(54) Marker System

(71) Applicant: ARCACHON HOLDINGS LLC, Clearwater, FL (US)

(72) Inventors: Gary Leegate, Clearwater, FL (US); Marcia Baldwin, Clearwater, FL (US); Dean J. Long, Bradenton, FL (US)

(73) Assignee: ARCACHON HOLDINGS LLC, Clearwater, FL (US)

(21) Appl. No.: 15/091,596

(22) Filed: Apr. 6, 2016

Related U.S. Application Data
(60) Provisional application No. 62/163,104, filed on May 18, 2015.

(51) Int. Cl. F21V 33/00; F21V 21/30; A42B 3/04; F21V 23/04; F21V 23/02; H05B 33/08; F21L 4/00

(52) U.S. Cl. CPC F21V 33/0076; H05B 33/086; F21V 21/30; F21L 4/00; F21V 23/0414; F21V 23/023; F21V 23/0442; A42B 3/044; F21Y 2101/02; F21Y 2113/007

(57) ABSTRACT

A marker system has a first section of an enclosure and a second section of the enclosure with a pivot rotatably connecting the first section to the second section. In such, the first section is adjustable from being in line with the second section to forming an arc with the second section, thereby conforming to multiple surface curvatures. There are several emitters within the enclosure and there is electronics (discrete electronics and/or a processor) for controlling the emitters responsive to user controls. For example, in a first mode, the emitters emit a light that is visible to the human eye through the enclosure and in a second mode; the emitters emit a light that is invisible to the human eye through the enclosure.

### CROSS-REFERENCE TO RELATED APPLICATION

This application claims the benefit of U.S. provisional application No. 62/163,104 filed on May 18, 2015. This application is related to U.S. patent application Ser. No. 14/515,918, filed Oct. 16, 2014, the disclosure of which is hereby incorporated by reference.

### FIELD

This invention relates to the field of helmet-mounted or helmet-integrated marker lights and in particular to a system that mounts to objects with different radii and curvature.

### BACKGROUND

Marker systems are known and used in various scenarios. In some uses, marker systems are used to provide indications of the location of other personnel, for example in dark-of-night situations when parachuting from an aircraft. In some marker systems, light is emitted in either visible or non-visible (to the naked eye) wavelengths. Non-visible wavelengths of light provide support for covert operations, requiring night-vision devices to see others. In some marking systems, complex switching between OFF and ON/Covert, and/or between OFF and ON/Visible is provided to reduce human error. It is dangerous to mistakenly enable visible-wavelength light during a covert operation.

Some such marking systems include a receiver that receives and decodes a signal from another party and, if a correct sequence is received, the marker responds in a predicted way to indicate that the associated object (e.g., a combatant, a military dog, a vehicle) is a “friend” as opposed to being a “foe.” Also, some such marking systems include mechanisms to program functions, either at the factory or in the field.

In the past, such devices were provided for helmet mounting, typically having a concave base where the radius of the concave surface matches the anticipated, typical curvatures of a typical helmet. Such packaging works well for some surfaces on a typical helmet, but the fixed concavity of the mounting surface does not match the curvature of all helmets, or all the varying curvatures on any given helmet, or other mounting locations such as on a soldier's battle dress, modular light-weight load carrying equipment (MOLLE), or equipment or the harness of a military dog, etc.

What is needed is a marking system that will adapt to and mount on a range of surfaces of different curvatures.

### SUMMARY

In one embodiment, a marker system is disclosed including a first section of an enclosure having a first bottom surface and a second section of the enclosure having a second bottom surface. A pivot (or hinge) rotatably connects the first section to the second section, such that the first bottom surface is adjustable from being in line with the second bottom surface to forming an angle with respect to the second bottom surface, thereby conforming to multiple surface curvatures. There are a plurality of emitters within the enclosure and electronics for controlling the emitters responsive to user controls such that in a first mode, the emitters emit a light that is visible to the human eye through the enclosure; and in a second mode, the emitters emit a light that is invisible to the human eye through the enclosure.

In another embodiment, a marker system is disclosed including a an enclosure having a first section and a second section; the first section of the enclosure has a first bottom surface and the second section of the enclosure has a second bottom surface. A pivot rotatably connects the first section to the second section such that the first bottom surface is adjustable from being in line with the second bottom surface to forming an angle with respect to the second bottom surface, thereby conforming to multiple surface curvatures. A controller (e.g., processor and memory) is housed within the enclosure. A plurality of emitters are located within the enclosure and electrically interfaced to the controller such that, upon the controller initiating a flow of electric current though one or more of the emitters, the one or more of the emitters emit light through the enclosure. The controller controls the flow of electric current through the emitters such that in a first mode, the emitters emit a light that is visible to the human eye through the enclosure; and in a second mode, the emitters emit a light that is invisible to the human eye through the enclosure.

In another embodiment, a marker system is disclosed including an enclosure that has a first section and a second section. The first section of the enclosure has a first bottom surface and the second section of the enclosure has a second bottom surface. A hinge rotatably connects the first section to the second section such that the first bottom surface is adjustable from being in line with the second bottom surface to forming an angle with respect to the second bottom surface, thereby conforming to multiple surface curvatures (e.g. different helmet styles, etc.). A controller (e.g., processor and memory) is housed within the enclosure and a first switch is physically interfaced to the enclosure and electrically interfaced to the controller for selectively choosing a function. A second switch is also physically interfaced to the enclosure and electrically interfaced to the controller for selectively choosing an operating mode. At least one light emitting diode is mounted within the enclosure and electrically interfaced to the controller. An operating status configuration switch is physically interfaced to the enclosure and electrically interfaced to the controller for determining the status of the marker system by a user. A vibration device electrically interfaced to the controller. Software stored on a non-transitory storage associated with the controller runs on the controller to determine a mode based upon signals from the first switch and the second switch and, based upon the mode, the controller selectively provides electrical current to one or more of the at least one light emitting diode such that the one or more of the at least one light emitting diode emit light that exits the enclosure.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a hinged marker system.

FIG. 2A illustrates a side plan view of the hinged marker system in a fully extended, flat configuration.

FIG. 2B illustrates a side plan view of the hinged marker system in an articulated configuration to fit a contoured mounting surface.

FIG. 3 illustrates a top plan view of the hinged marker system.

FIG. 4 illustrates a bottom plan view of the hinged marker system.

FIG. 5 illustrates a schematic view of a marker system circuit.

FIG. 6 illustrates a perspective view of the hinged marker system showing a power source.

FIG. 7 illustrates a side plan view of the hinged marker system in a linear mode relating to mounting on a flat surface.

FIG. 8 illustrates a side plan view of the hinged marker system in a curved mode.

FIG. 9 illustrates a side plan view of the marker system in a partially curved mode conforming to a helmet.

FIG. 10 illustrates a top plan view of a second example of the marker system with a mechanical hinge/pivot.

FIG. 11 illustrates a bottom plan view of the second example of the marker system with a mechanical hinge/pivot.

FIG. 12 illustrates a side plan view of the second example of the marker system with a mechanical hinge/pivot in a linear mode relating to mounting on a flat surface.

FIG. 13 illustrates a side plan view of the second example of the marker system with a mechanical hinge/pivot in a curved mode.

FIG. 14 illustrates a perspective view of the second example of the marker system with a mechanical hinge/pivot with an, opaque cover.

FIG. 15 illustrates a top plan view of a fourth example of the marker system with a flexible material between sections.

FIG. 16 illustrates a bottom plan view of the fourth example of the marker system.

FIG. 17 illustrates a side plan view of the fourth example of the marker system in a linear mode relating to mounting on a flat surface.

FIG. 18 illustrates a side plan view of the fourth example of the marker system in a curved mode.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

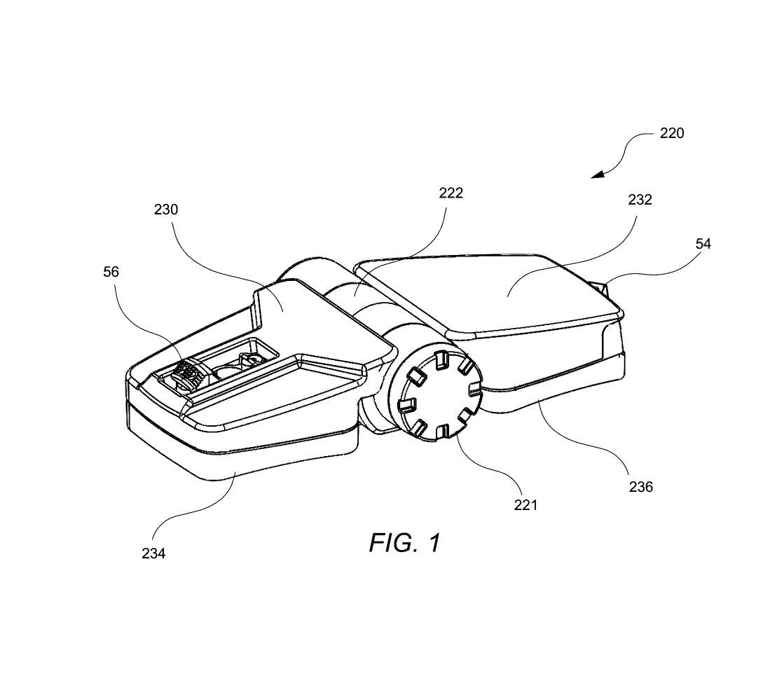

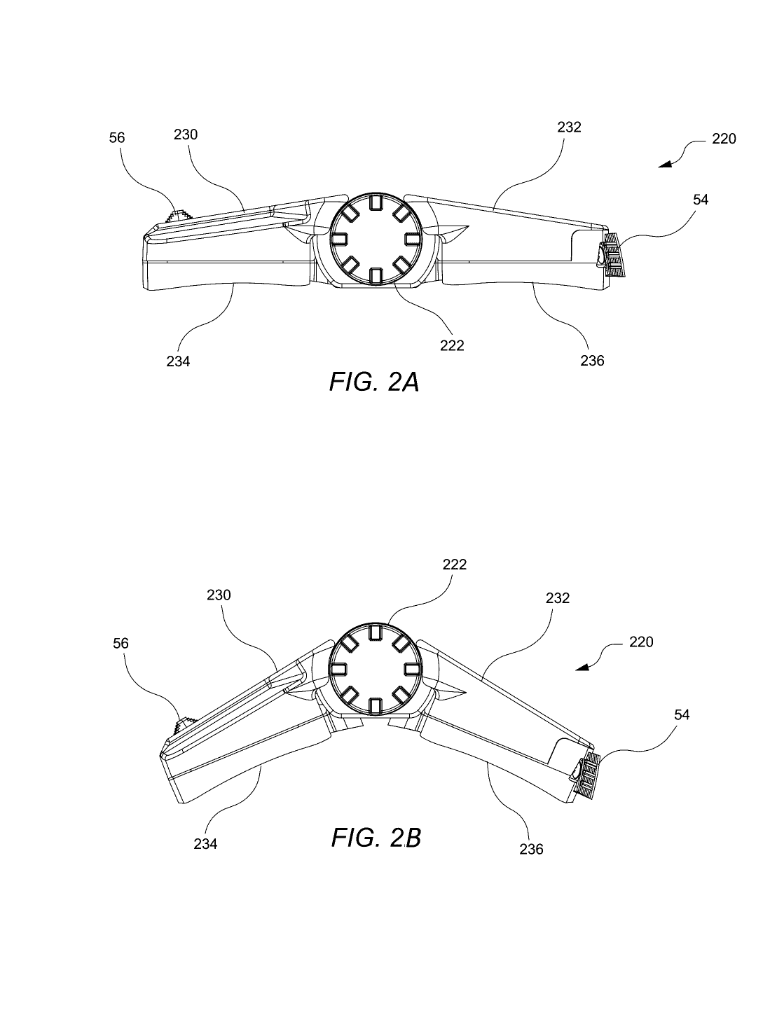

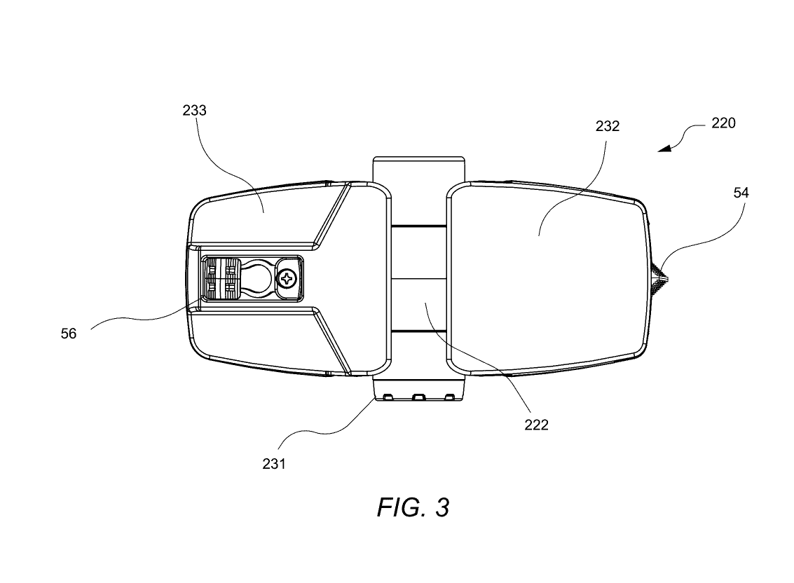

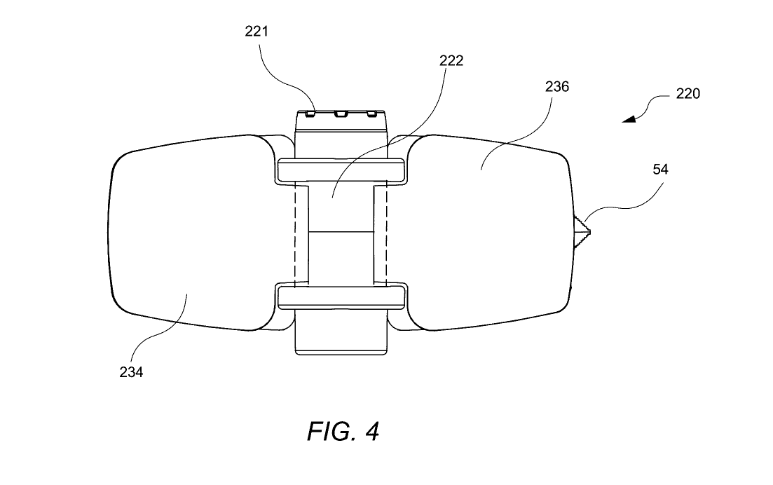

Referring to FIGS. 1, 2, 3, and 4, perspective, top and bottom views of a marker system 220 are shown. The marker system 220 has two sections 230/232 connected by a hinge or pivot 222, enabling a predetermined amount of rotation of a first section 230 with respect to a second section 232 as will be shown in later figures. In some embodiments, one or both sections 230/232 include a concavity on their respective equipment mounting surfaces 234/236 to facilitate mountable conformity to various helmet outer surfaces. In some embodiments, the concave mounting surfaces 234/236 further include an attachment media such as hook and loop material or double-sided adhesive tape material.

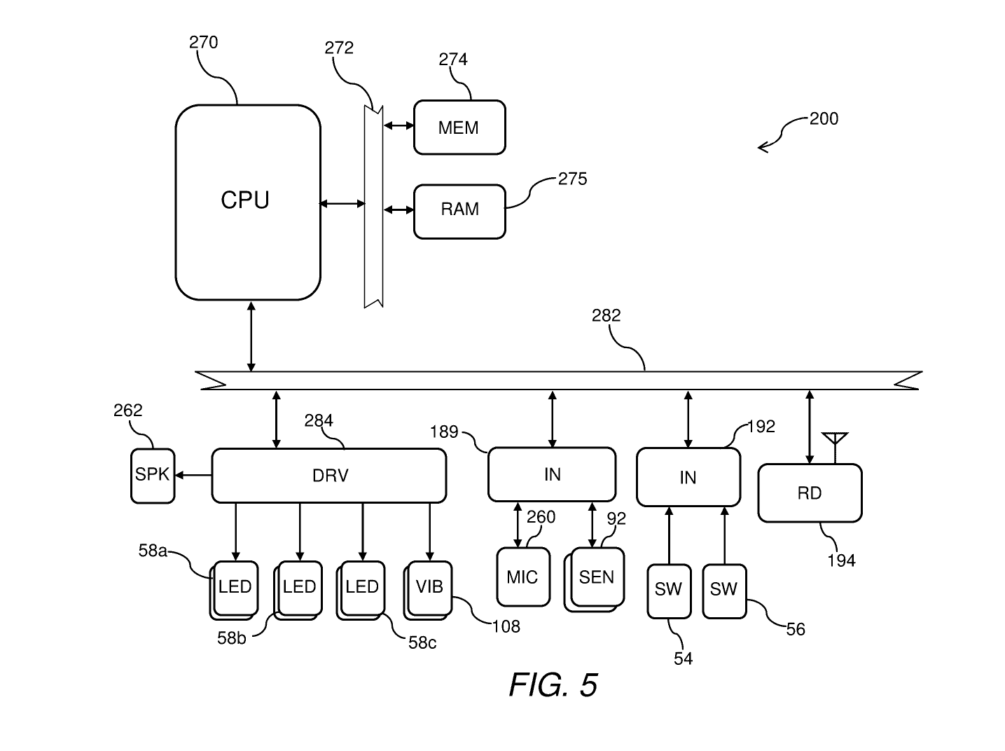

As will be shown with FIG. 5, the marker system 220 has, within either a first enclosure 230 and/or a second enclosure 232, any number of emitters 58a/58b/58c (e.g., LEDs), photo detectors 92, vibrators 108, power sources 223, processing elements 270, radio receiver or transceivers 194, speakers 262, microphones 260, etc. The components within the marker system 220 function to provide the marker functionality, emitting specific wavelengths of light through the first enclosure 230 and/or the second enclosure 232 under control of the switches 54/56 and, in embodiments having the ability to respond to interrogations as to friend or foe (IFF), the sensors 92 (e.g. photodiodes) receive light waves such as pulses of infrared light in a specific pattern or code and relay the pulses as an electrical signal to the processor 270. In some scenarios, the interrogations are initiated by remote a weapon-mounted infrared laser pointed by one combatant toward another unknown combatant. Software on the processor analyzes the pulses and determines if the pulses represent an incoming friendly interrogation, by determining if the pulses are of a predetermined sequence based upon one or more modulation schemes. If the software determines that a proper, friendly interrogation has been received, the software controls one of more of the emitters 58a/58b/58c to emit light in a prescribed wavelength and/or sequence. For example, responsive to an interrogation, the software controls the infrared emitters to flash a predetermined number of times, on for a predetermined period of time and off for a predetermined period of time, etc. Additionally, in some embodiments, the software, upon determining that a proper interrogation was received, alerts the wearer that an interrogation has occurred through one or more mechanisms such as a vibrator 108 (either located within the marker system 220 or located external to the marker system such as mounted within a helmet) or an audible output through, for example, a speaker 262, or a visual alert through, for example, a fiber optic cable or LED positioned on or near the front edge of the helmet so as to be seen by the wearer and not visible to other persons.

In this exemplary marker system, there are two switches 56/54 shown in a preferred location, though there is no requirement on any number of switches and/or location of such, when present. In this example, a first switch 54 is a sliding, three-position function switch (Function “0” [Off], Function “1”, Function “2”) and the second switch 56 is a two-position mode switch (for example, Mode “A” is overt/visible, and Mode “B” is covert/infrared) that requires a specific reorientation to change modes, therefore being difficult to move from covert to overt as such presents the possibility to spoil a covert military operation and put lives of friendly combatants in danger.

Referring to FIG. 5, a schematic view of a marker light circuit 200 is shown. The example marker light circuit 200 represents one possible circuit for achieving the desired marker light functionality, housed within any of the enclosures 230/232/1230/1232/1430. This exemplary marker light circuit 200 is shown in one form with a specific set of features, though other circuits are known to achieve similar results with more or less features, all of which are included here within. Different architectures are known that accomplish similar results in a similar fashion and the present invention is not limited in any way to any particular marker light architecture or implementation. In this exemplary marker light circuit 200, a processor 270 executes or runs programs in a random access memory 275. The programs are generally stored within a persistent memory 274 and loaded into the random access memory 275 when needed. The processor 270 is any processor, typically a processor designed for low-power, portable operation consuming the minimal amount of power, e.g., a programmable interrupt controller, etc. The persistent memory 274 and random access memory 275 are connected to the processor by any architecture known in the computer industry, for example, by a memory bus 272. The random access memory 275 is any memory 275 suitable for connection and operation with the selected processor 270, such as SRAM, DRAM, SDRAM, RDRAM, DDR, DDR-2, etc. The persistent memory 274 is any type, configuration, capacity of memory 274 suitable for persistently storing data, for example, flash memory, read only memory, battery-backed memory, magnetic memory, etc. In some embodiments, the persistent memory 274 is removable, in the form of a memory card of appropriate format such as SD (secure digital) cards, micro SD cards, compact flash, etc.

Also connected to the processor 270 is a system bus 282 for connecting to input ports 189/192 for receiving signals from sensors 92, microphones 260, and switch inputs 54/56. Likewise output ports/drivers 284 drive emitters 58a/58b/58c (e.g., LEDs), vibrators 108, and speakers/sounders 262.

In general, some portion of the memory 274 is used to store programs, executable code, and parameters such as operating states and programmable features.

The radio 194, when present, is any known radio in the industry such as a Global Positioning Subsystems receiver 194, Bluetooth transceivers 194, Wi-Fi transceivers 194, etc., the likes of which are not shown for brevity and clarity reasons.

For communications with operations and/or programming, some embodiments include a radio receiver and/or transceiver 194, operating on any wavelength as desired. In some embodiments, a base station communicates with the radio transceiver 194 to ascertain that the wearer of the marking system 220 is a friend. In some embodiments, a signal (e.g., an encoded signal) is transmitted to the radio 194 and decoded by the processor 270 and software, and responsive to recognition of the signal, the processor 270 illuminates one or more LEDs 58a/58b/58c, in some embodiments in a sequence or pattern, informing personnel that operate the base station that the wearer is a friend (lack of response indicates a possible foe). In some embodiments, a response signal is transmitted through the radio 194 to indicate that a “friend” is being interrogated.

In some embodiments, a first, operating function switch 54 and a second, operating mode switch circuit 56 are interfaced to the processor 270 through an input port 192. The switches 54/56 control multi-function, multi-emission, multi-mode features of the marker system 220, through signals provide to software running on the processor 270. For example, steady illumination, flashing patterns, sequencing, and/or brightness of one or several of the emitters 58a/58b/58c are programmed and controlled by software running on the processor 270. In one embodiment, the sliding main switch 54 has three positions: OFF (Function“0”) and two selectable operating functions (Functions “1” and “2”). The sliding main switch 54 is ergonomically actuated by the wearer without the wearer needing to see the sliding main switch 54 by way of tactile feel while the marker light is mounted, for example, on a helmet. The sliding operating mode switch 56 is also in electrical communication with the processor 270. In some embodiments, the sliding operating mode switch 56 has two operating modes, e.g., Mode “A” (such as overt or visible) or Mode “B” (such as covert or infrared). In such, it is preferred that the sliding operating mode switch 56 requires an overt operation to change state to prevent inadvertent changes to the operating mode, as changing from covert (infrared) to overt (visible) during covert military operation is often very dangerous.

In embodiments in which radiation is received by one or more light sensors 92 enclosed on or within the enclosure of the marker system 220, the light of one or more wavelengths of light are detected by the one or more light sensors 92, indicating such through an electrical interface to the processor 270 for impacting of the software running on the processor 270.

Any number of emitters 58a, 58b, 58c comprises, for example, any variety, type, and light spectrum of LEDs disposed on or within the first enclosure 230 and/or the second enclosure 232 of the marker system 220. The emitters 58a, 58b, 58c are, for example, Red/Green/Blue (RGB) three-chip LEDs 58a, multiple high-intensity “white” light LEDs 58b, and multiple infrared (IR) emitters and/or LEDs 58c which may emit in one or more different infrared wavelengths.

The emitters 58a, 58b, 58c and sensors 92 are located on or within the enclosure of the marker system 220 such that light from outside of the marker system 220 is exposed to the sensors 92 and light from the emitters 58a, 58b, 58c exits the enclosure.

Any of the emitters 58a, 58b, 58c are illuminated under control of the processor 270 at the same time individually or in tandem with other emitters 58a/58b/58c, in any pattern (flashing) or steadily illuminate. For example, in one operating mode four RGB light sources 58a are operating in constant Green/Steady while two high intensity white light sources 58b are simultaneously operating intermittently in a flashing mode.

In some embodiments, a tactile signal to the wearer of the marker system is provided by a vibration device 108. The tactile signal (e.g. vibration) is provided, under program control by the processor, after, for example, a specified military infrared friend or foe interrogation has been received by the sensors 92 or radio 194 and properly decoded by software running on the processor 270. The vibration device is one or more vibration motors either embedded in the marker system 220 or located in a remote vibratory pad interfaced to one of the enclosures or sub-enclosures (not shown, but for example, positioned within the helmet). When an interrogation is received, vibration from the vibration device 108 is felt by the wearer either through the vibratory pad that is placed within the helmet, or through vibrations imparted to the helmet through the vibratory motor within the marker system 220.

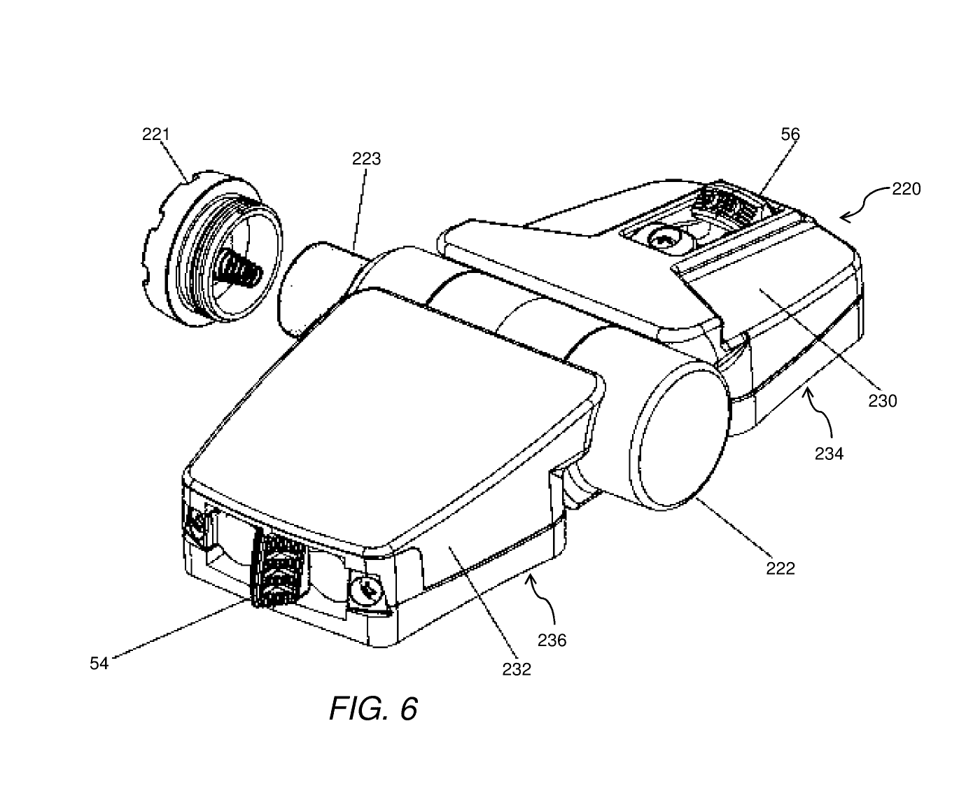

Referring to FIG. 6, a perspective view of the marker system 220 showing a power source 223 is shown. In some embodiments, the power source 223 (e.g., a battery 223 or rechargeable battery 223) is housed in the hinge or pivot 222, being removable by way of a cap 221 that attaches to the pivot 222 by, for example, threads or snaps, preferably making a water resistant seal against the pivot 222 to reduce potential for moisture intrusion into the battery holding area (not visible). In alternate embodiments, the power source 223 (e.g., battery 223) is located in other enclosures or sub-enclosures 230/232/1230/1232/1430 within or external to the marker system 220.

In some embodiments, the hinge or pivot 222 adapts to different sizes and/or geometries of power sources 223 through adapters or tooling changes.

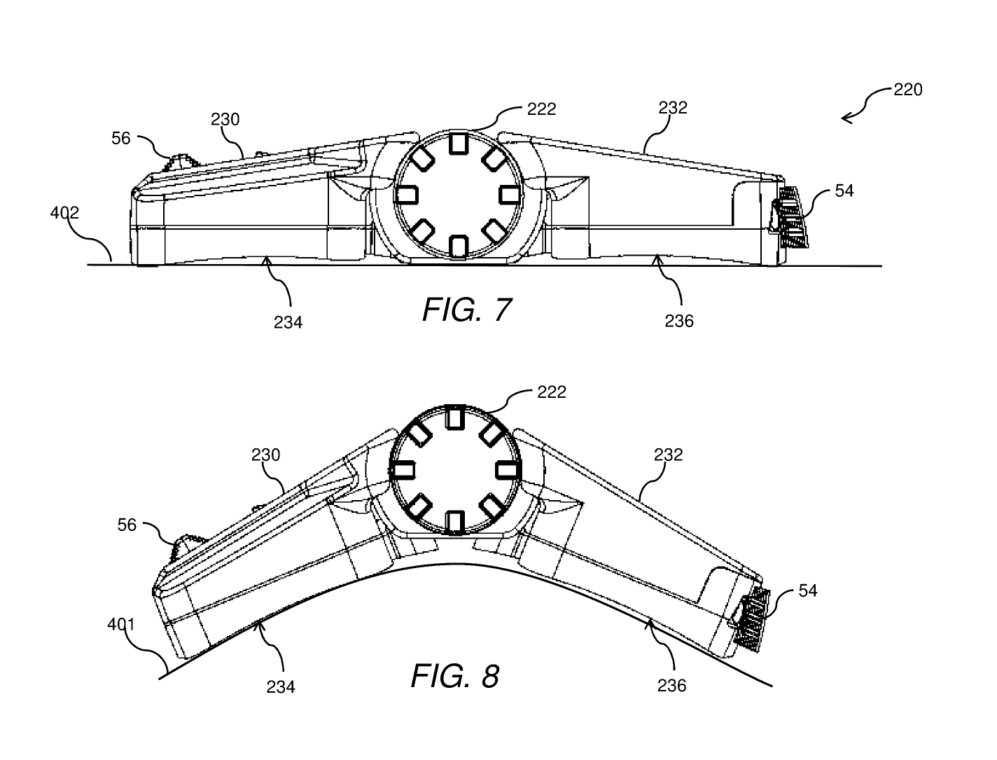

Referring to FIG. 7, a side plan view of the marker system 220 is shown in a linear mode. In this view, the marker system 220 is rotated along the pivot 222 to approximate a flat surface 402 or a nearly flat surface 402 such as modular light-weight load carrying equipment (MOLLE), including armor plate carriers and tactical back packs or an object such as an aerial delivery load, military vehicle, or other military equipment, etc.

Referring to FIG. 8, a side plan view of the marker system 220 is shown in a curved mode. In this view, the marker system 220 is rotated along the pivot 222 to approximate a highly curved surface 401 such military helmet, or a harness installed on the back of a military dog, etc.

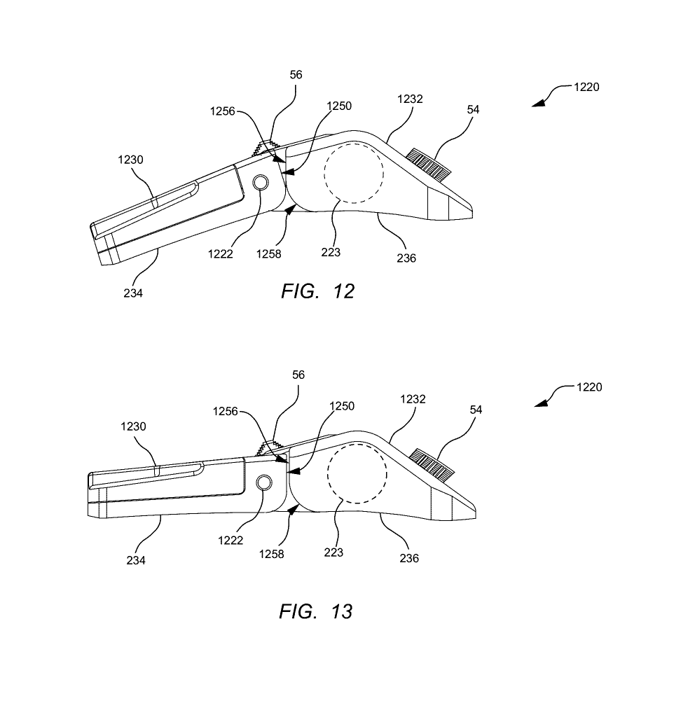

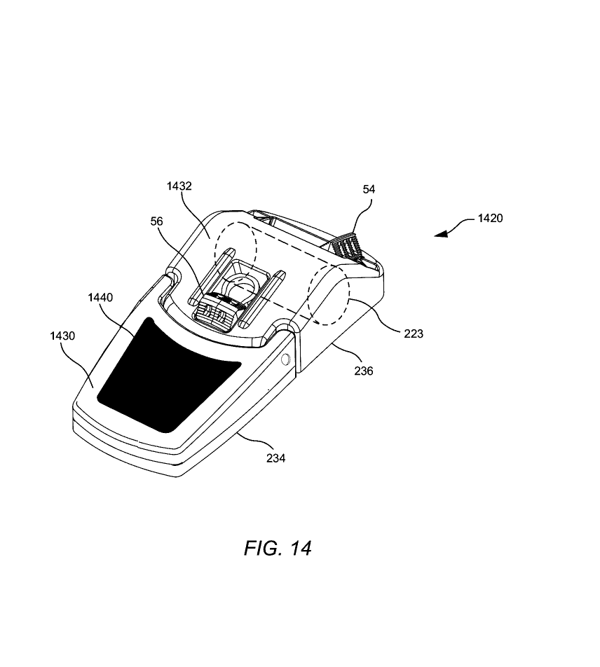

Note that, although not required, in some embodiments there are features to limit the rotation of the first enclosure 230/1230/1430 of the marker system 220 with respect to the second enclosure 232/1232/1432 of the marker system 220. For example, the rotation/curvature is limited between substantially linear (as in FIG. 7, and FIG. 12) and curved along on specific arc at an angle with respect to each other (as in FIG. 8 and FIG. 14) and any curvature/angle between such. FIGS. 12 and 13 provide an example of rotation-limiting features 1250, 1256, 1258 that apply to the second marker system 1220 and the third marker system 1420.

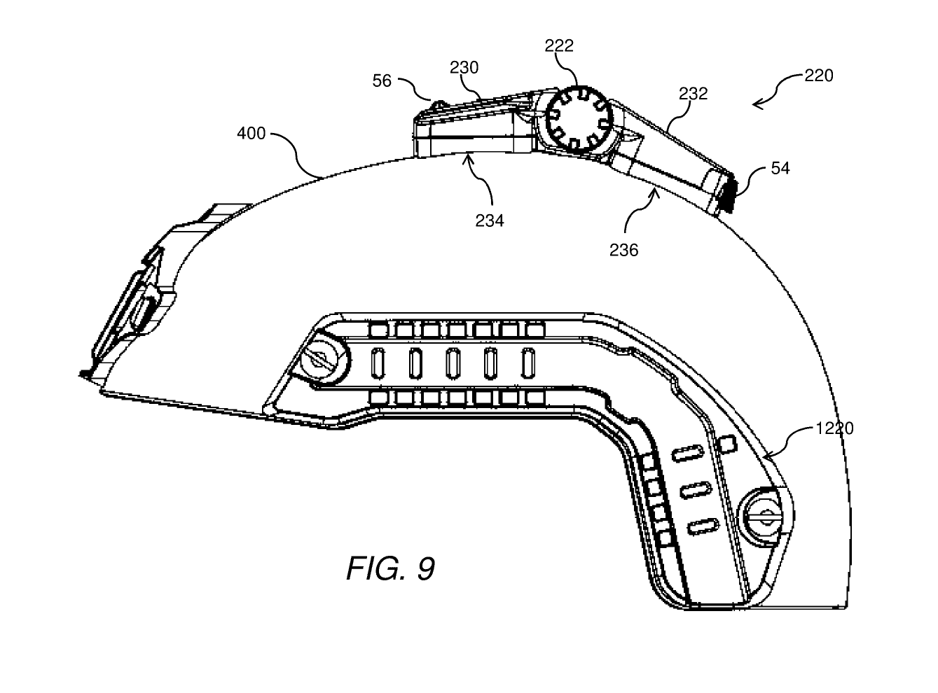

FIG. 9 illustrates a side plan view of the marker system 220 in a partially curved mode conforming to a helmet 400. This is shown as an example of how the marker system 220 mounts to a helmet 400. Note that in some embodiments, the marker system 220 is mounted using hook and loop materials, rails, adhesive, straps, etc. (all not shown for brevity) on equipment mounting surfaces 234/236.

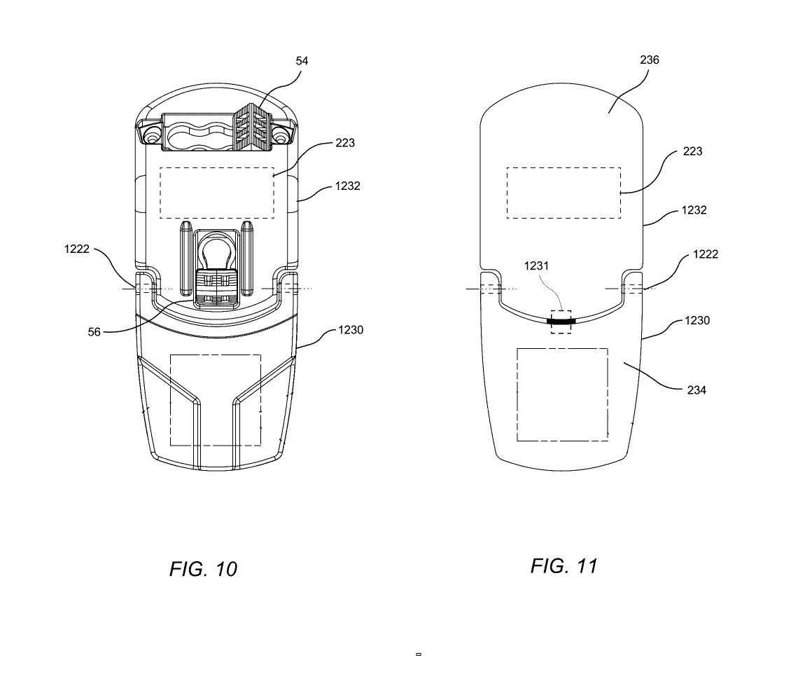

Referring to FIGS. 10 and 11, top plan views of a second example 1220 of the marker system are shown. In this example, the second marker 1220 has two separate enclosure portions 1230/1232 that are allowed to pivotally change orientation with respect to each other by way of a pivot 1222 (see FIGS. 12 and 13). The operation of the second marker 1220 is similar to that of the marker system 220. Emitters 58a/58b/58c, marker light circuit 200, and optionally detectors 92 are housed within the first sub-enclosure 1230 while operation control switches 54/56 and a power source (not visible) are interfaced or contained within the second sub-enclosure 1232. There is an electrical interface 1231 running between the first sub-enclosure 1230 and the second sub-enclosure 1232 for providing electrical signals to the emitters 58a/58b/58c and receiving detection signals from the optional detectors 92, etc.

Referring to FIGS. 12 and 13, side plan views of the second marker system 1220 are shown in a linear mode relating to mounting on a flat surface (FIG. 12) and in a curved mode (FIG. 13). As with the marker system 220, the second marker system bends along the pivot 1222 to conform to surfaces ranging from linear surfaces to curved surfaces as would be expected in helmet mounting. In FIG. 12, the second marker system 1220 is shown slightly curved while in FIG. 13, the second marker system 1220 is shown substantially linear. Note that the formation of the second sub-enclosure 1232, in some embodiments, includes limit edges 1256/1258 on the second sub-enclosure 1232 that interface with an edge 1250 of the first sub-enclosure 1230 to limit the amount of bending between, for example, linear and a maximum angle between the first sub-enclosure 1230 and the second sub-enclosure 1232.

Referring to FIG. 14, a perspective view of a third marker system 1420 with a separate cover 1440 is shown. In this example, the third marker 1420 has two separate enclosure portions 1430/1432 that are allowed to pivotally change orientation with respect to each other by way of a pivot 1222. The operation of the third marker 1420 is similar to that of the marker 220. Emitters 58a/58b/58c, optionally the marker light circuit 200, and optionally detectors 92 are housed within a substantially clear, or translucent first sub-enclosure 1430 while operation control switches 54/56 and a power source (not visible) are interfaced or contained within the second sub-enclosure 1432. In the third marker 1420, a cover 1440, being a separate component than the first sub-enclosure 1430, covers and forms a seal over a cavity in the first sub-enclosure 1430, encapsulating the emitters 58a/58b/58c, optionally the marker light circuit 220 and optionally detectors 92. At least a portion of the top surface of the cover 1440 is preferably opaque, preventing light from the emitters 58a/58b/58c from escaping the first sub-enclosure 1420 through the cover 1440 and preventing light from external sources from entering the first sub-enclosure 1430 through the cover 1440. The other surfaces of the first sub-enclosure 1430 are anticipated as being at least translucent, allowing light to pass through the other surfaces of the first sub-enclosure 1430.

In some embodiments, the lower/interior surface of the cover 1440 includes reflective, refractive, or light guiding surfaces to guide and optimally disperse the light generated by the emitters 58a, 58b, 58c through the clear or translucent top surface of the first sub-enclosure 1430 bounded by the opaque cover 1440, and through the clear/translucent sides of the first sub-enclosure 1430. In some embodiments, the optional detectors 92 are mounted in the cover 1440 for detection of incoming interrogations. It is also anticipated that in some embodiments, the cover 1440 be added at later stages of manufacturing to provide last-minute production configurability (e.g., one configuration having only emitters 58a/58b/58c and another configuration having emitters 58a/58b/58c and detectors 92, etc.). in some embodiments, the cover 1440 is removable to facilitate easy access for later repair and/or replacement of emitters 58a/58b/58c and detectors 92.

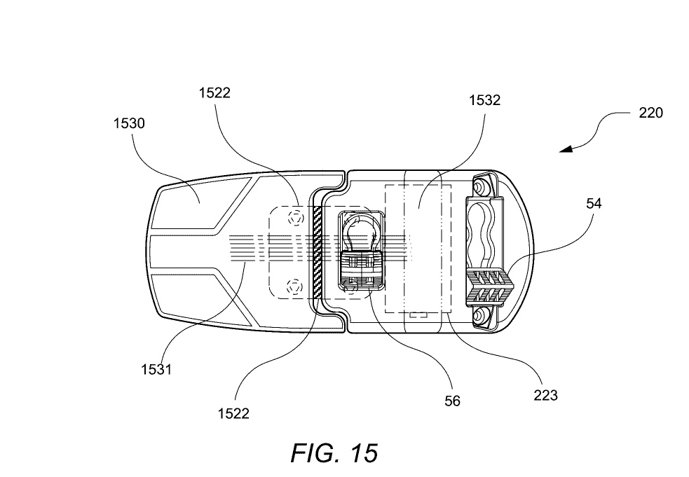

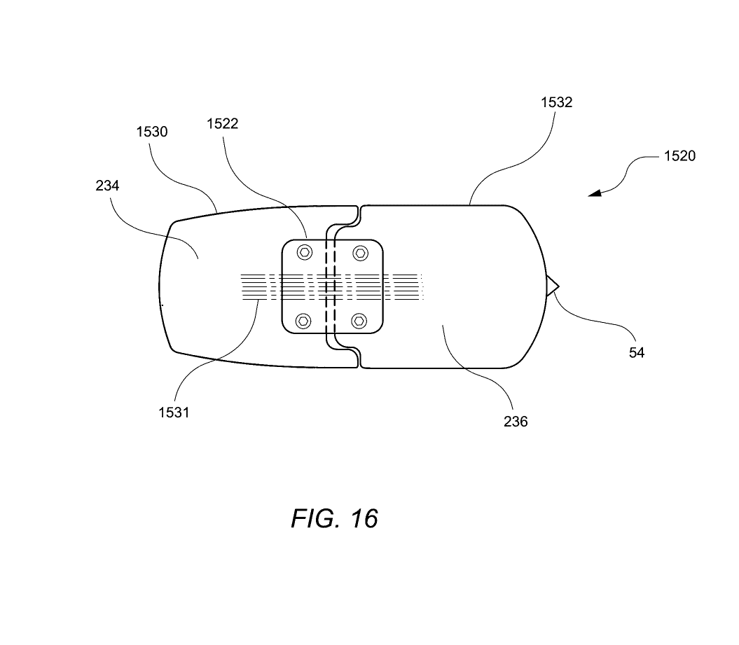

Referring to FIGS. 15 and 16, top and bottom plan views of a bendable marker system 1520 are shown. In this example, the bendable marker system 1520 has two separate enclosure portions 1530/1532 that are allowed to change orientation with respect to each other by way of a flexible material 1522 that joins the enclosure portions 1530/1532. The flexible material 1522 is molded or fabricated of a flexible, environmentally robust rubber-like material(s) and does not rely upon rotating mechanical pivots or hinges. The operation of the second marker 1520 is similar to that of the marker system 220. Emitters 58a/58b/58c, marker light circuit 200, and optionally detectors 92 are housed within the first sub-enclosure 1530 while operation control switches 54/56 and a power source 223 are interfaced to or contained within the second sub-enclosure 1532. The electrical interface 1531 runs between the first sub-enclosure 1530 and the second sub-enclosure 1532 which provides for electrical signals to the emitters 58a/58b/58c and receiving detection signals from the optional detectors 92, etc. In some embodiments, the electrical interface 1531 is embedded within the flexible material 1522 as part of an injection over-mold process or permanently bonded between two flexible substrates that comprise the flexible material 1522. The ends of the flexible material 1522 mate and secure, preferably in a waterproof manner, to both the first sub-enclosure 1530 and the second sub-enclosure 1532, in some embodiments, leaving a middle section of the flexible material 1522 exposed between the first and second sub-enclosures 1530 and 1532, thus providing bendability between the sub-enclosures 1530/1532.

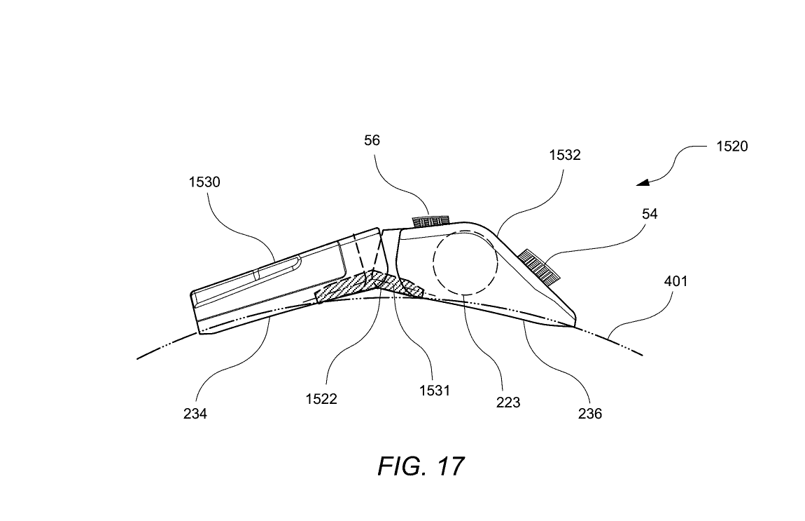

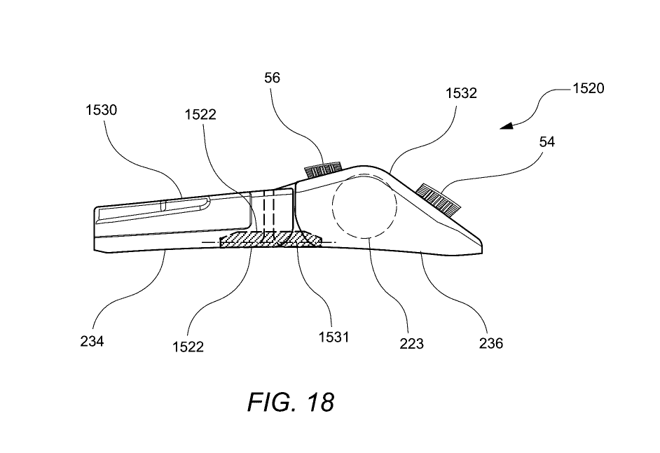

Referring to FIGS. 17 and 18, side plan views of the bendable marker system 1520 are shown in a linear mode relating to mounting on a flat surface (FIG. 17) and in a curved mode (FIG. 18). Similar to the marker system 220, the bendable marker system 1520 bends or flexes along the flexible material 1522 to allow the first and second sub-enclosures 1531 and 1532 to conform to surfaces ranging from linear surfaces 402 (as in FIG. 17) to curved surfaces 401 (as in FIG. 18) for example, when mounted to a helmet. In FIG. 17, the bendable marker system 1520 is shown substantially linear while in FIG. 18, the bendable marker system 1520 is shown slightly curved to fit a helmet curvature.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A marker system comprising:
a first section of an enclosure having a first bottom surface;
a second section of the enclosure having a second bottom surface;
a connection between the first section to the second section, such that the first bottom surface is adjustable from being in line with the second bottom surface to forming an angle with respect to the second bottom surface, thereby conforming to multiple surface curvatures;
a plurality of emitters within the enclosure; and
means for controlling the emitters responsive to user controls such that in a first mode, the emitters emit a light that is visible to the human eye through the enclosure and in a second mode, the emitters emit a light that is invisible to the human eye through the enclosure.

2. The marker system of claim 1, wherein the means for controlling comprises a processor and a program running on the processor, whereas the program receives inputs from at least one switch and, responsive to the at least one switch, the program controls which of the emitters emit light.

3. The marker system of claim 2, further comprising at least one detector configured to receive light emanating from outside of the enclosure and converting the light into an electrical signal, the electrical signal interfaced to an input of the processor and the program running on the processor monitors the electrical signal looking for a specific sequence, the sequence indicating an interrogation, and upon finding the specific sequence, the program signals one or more of the emitters to emit light in a response sequence indicating that the interrogation has been received.

4. The marker system of claim 3, wherein upon finding the specific sequence, the program signals a vibration device indicating that the interrogation has been received for notifying a wearer of the marker system.

5. The marker system of claim 1, wherein the connection is a pivot and a power source for the marker system is housed within the pivot.

6. The marker system of claim 5, wherein the power source is a battery.

7. The marker system of claim 1, wherein the first bottom surface and the second bottom surface are planar.

8. The marker system of claim 1, wherein the first bottom surface and the second bottom surface are concave.

9. A marker system comprising:
an enclosure having a first section and a second section; the first section of the enclosure having a first bottom surface and the second section of the enclosure having a second bottom surface;
a pivot rotatably connecting the first section to the second section, such that the first bottom surface is adjustable from being in line with the second bottom surface to forming an angle with respect to the second bottom surface, thereby conforming to multiple surface curvatures;
a controller housed within the enclosure;
a plurality of emitters located within the enclosure and electrically interfaced to the controller such that, upon the controller initiating a flow of electric current though one or more of the emitters, the one or more of the emitters emit light through the enclosure; and
the controller directs the flow of electric current through the emitters such that in a first mode, the emitters emit a light that is visible to the human eye through the enclosure and in a second mode, the emitters emit a light that is invisible to the human eye through the enclosure.

10. The marker system of claim 9, further comprising:
at least one detector electrically interfaced to the controller, the at least one detector for detecting light in of a specific wavelength and converting the light to an electrical signal that is received by the controller; and
software stored on a non-transitory storage associated with the controller, the software monitoring the at least one detector for an encoded incoming interrogations as to friend or foe (IFF) signal, the software initiating the flow of electric current through a selected set of the plurality of emitters responsive to receiving, decoding, and detecting the encoded incoming IFF signal from the at least one detector.

11. The marker system of claim 10, wherein upon detecting the encoded incoming IFF signal, the program signals a vibration device for notifying a wearer of the marker system.

12. The marker system of claim 9, whereas the controller receives inputs from at least one switch and, responsive to the at least one switch, the program controls which of the emitters emit light.

13. The marker system of claim 9, wherein a power source for the marker system is housed within the pivot.

14. The marker system of claim 13, wherein the power source is a battery.

15. The marker system of claim 9, wherein the first bottom surface and the second bottom surface are planar.

16. The marker system of claim 9, wherein the first bottom surface and the second bottom surface are concave.

17. A marker system, comprising:
an enclosure having a first section and a second section; the first section of the enclosure having a first bottom surface and the second section of the enclosure having a second bottom surface;
a hinge rotatably connecting the first section to the second section, such that the first bottom surface is adjustable from being in line with the second bottom surface to forming an angle with respect to the second bottom surface, thereby conforming to multiple surface curvatures;
a controller housed within the enclosure;
a first switch physically interfaced to the enclosure and electrically interfaced to the controller, the first switch for selectively choosing a function;
a second switch physically interfaced to the enclosure and electrically interfaced to the controller, the second switch for selectively choosing an operating mode;
at least one light emitting diode within the enclosure and electrically interfaced to the controller;
an operating status configuration switch physically interfaced to the enclosure and electrically interfaced to the controller, the operating status configuration switch for determining the status of the marker system;
a vibration device electrically interfaced to the controller;
software stored on a non-transitory storage associated with the controller, the software running on the controller determines a mode based upon signals from the first switch and the second switch and, based upon the mode, the controller selectively provides electrical current to one or more of the at least one light emitting diode such that the one or more of the at least one light emitting diode emit light that exits the enclosure.

18. The marker system of claim 17, further comprising:
at least one detector configured to receive light emanating from outside of the enclosure and converting the light into an electrical signal, the electrical signal interfaced to an input of the controller; and
the software running on the controller monitors the electrical signal looking for a specific sequence, the sequence indicating an interrogation, and upon detecting the specific sequence, the program signals one or more of the emitters to emit light in a response sequence indicating that the interrogation has been received.

19. The marker system of claim 18, wherein upon the specific sequence, the software running on the controller signals a vibration device to vibrate for notifying a wearer of the marker system.

20. The marker system of claim 17, wherein the hinge is formed from a flexible material.
